(19) United States
(12) Patent Application Publication
(10) Pub. No.: US 2005/0188061 A1
(43) Pub. Date: Aug. 25, 2005

(54) Electronic matching system

(76) Inventor: Jack Sandler Bloom, New York, NY (US)

Correspondence Address: Dwayne L. Bentley;LAW OFFICE OF DWAYNE L. BENTLEY, Suite 1112, 16 Court Street, Brooklyn, NY, 11241, US

(21) Appl. No.: 10/785,630

(22) Filed: Feb. 24, 2004

(51) Int. Cl. G06F 15/177

(52) U.S. Cl. 709/220

(57) ABSTRACT

The present invention provides a system for matching one entity to another. The system includes a first computer coupled to a network, where the first computer is configured to transmit a first set of private requirements information including a first user defined determining aspect to the network. The network is coupled to a server, where the server is configured to receive the first set of private requirements information with the first user defined determining aspect. A second computer is coupled to the network, where the second computer is configured to transmit a second set of private requirements information with a second user defined determining aspect to the network. The server is coupled to the network, where the server is configured to receive the first and second set of private requirements information, where the server is configured to determine if there is a match between the first and second set of private requirements information based on the first and second users defined determining aspects.

This invention relates to a system for matching individuals and the like.

### BACKGROUND OF THE INVENTION

The twentieth-century world is chaotic and hectic, where people don't have time to get to know each other. Since people don't have the time to know each other they are less likely to meet someone they can be romantically involved, meet a good friend or someone they can form a good business relationship with. The average person's lives are filled with a multitude of tasks, such that he is not afforded the time to meet someone.

People manage their demanding lives to meet other people at bars, clubs, restaurants and other social venues. However, these venues have not been thoroughly successful in matching people up. Thus, internet dating or computer dating has become prevalent in the twenty-first century, because it offers people a means to meet people from the comfort of their home or office where they don't feel as vulnerable as if they were at a social venue. In addition, internet dating gives people an opportunity to know people based on their personalities instead of just their appearance.

However, there are some problems associated with internet dating, such as a person not being able to quickly discern if another person meets his important requirements before the relationship starts. For some people, these important requirements are absolute requirements for dating. These type of absolute requirements may not be politically correct to say, but as the dating person you should have the right to decide what the other person must have in order to date them. These absolute requirements are often overlooked by the current internet dating programs that usually match people based on a set of criteria determined by the dating company instead of allowing the consumer choose which requirements matter the most.

With respect to forming potential business relationships, job searches, product procurements and investors looking to buy a company, people are not able to privately seek out other people in these corresponding fields. For example, if a job candidate is comfortable at his company, but still wants to find a company that fits his wants and needs and he does not want to do it publicly, then he doesn't have an outlet to privately find a corporation that matches his needs. Similarly, if a corporation wants to privately find a job candidate, the corporation may be unable to do so with the current available public methods. In another example, Company A may want to privately look for a product for their device that may be cheaper than the product they currently receive from the manufacturer, but they don't want to cause the manufacturer to be concerned that Company A will go elsewhere for the product. People want and need the ability to privately perform job searches, procure products, form potential business relationships and invest in companies without having to be troubled with being publicly exposed.

Therefore, there is a need for a device that allows a person to more appropriately and privately match his true wants and needs with the true wants and needs of another person to make a more appropriate match.

### BRIEF SUMMARY OF THE INVENTION

The present invention has been accomplished in view of the above-mentioned technical background, and it is an object of the present invention to provide a simple, worry-free means for matching a first person to another person based on a criteria established by the first person.

In a first preferred embodiment of the invention, a system for matching one entity to another is disclosed. The system includes a first computer coupled to a network, where the first computer is configured to transmit a first set of private requirements information including a first user defined determining aspect to the network. The network is coupled to a server, where the server is configured to receive the first set of private requirements information with the first user defined determining aspect. A second computer is coupled to the network, where the second computer is configured to transmit a second set of private requirements information with a second user defined determining aspect to the network. The server is coupled to the network, where the server is configured to receive the first and second set of private requirements information, where the server is configured to determine if there is a match between the first and second set of private requirements information based on the first and second user defined determining aspects.

In another preferred embodiment of the invention, a method for matching one entity to another entity is disclosed. A first set of private requirements information with a first user defined determining aspect is transferred. The first of private requirements with the first determining aspect is received. Next, a second set of private requirements information with a second user defined determining aspect is transferred. The second set of private requirements information with the second user defined determining aspect is received. Next, there is a determination if there is a match between the first and second set of private requirements information based on the first and second users defined determining aspects.

In yet another preferred embodiment, there is an apparatus for matching one entity to another entity. The apparatus includes: a receiver interface configured to receive a first and second set of private requirements information with a first and second user defined determining aspects; a storage device coupled to the connection interface configured to store the first and second set of private requirements with the first and second user defined determining aspects; and a processor coupled to the storage device configured to determine if there is a match between the first and second set of private requirements information based on the first and second users defined determining aspects.

### BRIEF DESCRIPTION OF SEVERAL VIEWS OF THE DRAWINGS

These and other advantages of the present invention will become more apparent as the following description is read in conjunction with the accompanying drawings, wherein:

FIG. 1 illustrates a block diagram of an embodiment of an electronic matching system in accordance with an embodiment of the invention;

FIG. 2 illustrates a schematic diagram of the embodiment of the electronic matching system of FIG. 1 in accordance with the invention;

FIG. 3 depicts a flow-chart of a method employed by the embodiment of the electronic matching system of FIG. 1 that matches a first end user with a second end user in accordance with the invention;

FIG. 4 illustrates an example of the public information of the first end user that may be displayed on the accessible website associated with the embodiment of the electronic matching system of FIG. 1 in accordance with the invention;

FIG. 5 illustrates an example of the private requirements information attributes, rankings and importance level of the first end user that may be displayed on the accessible website associated with the embodiment of the electronic matching system of FIG. 1 in accordance with the invention;

FIG. 6 illustrates an example of the public information of the second end user that may be displayed on the accessible website associated with the embodiment of the electronic matching system of FIG. 1 in accordance with the invention;

FIG. 7 illustrates an example of the private requirements information attributes, rankings and importance level of the second end user that may be displayed on the accessible website associated with the embodiment of the electronic matching system of FIG. 1 in accordance with the invention.

### DETAILED DESCRIPTION OF THE INVENTION

The presently preferred embodiments of the invention are described with references to the drawings, where like components are identified with the same numerals. The descriptions of the preferred embodiments are exemplary and are not intended to limit the scope of the invention.

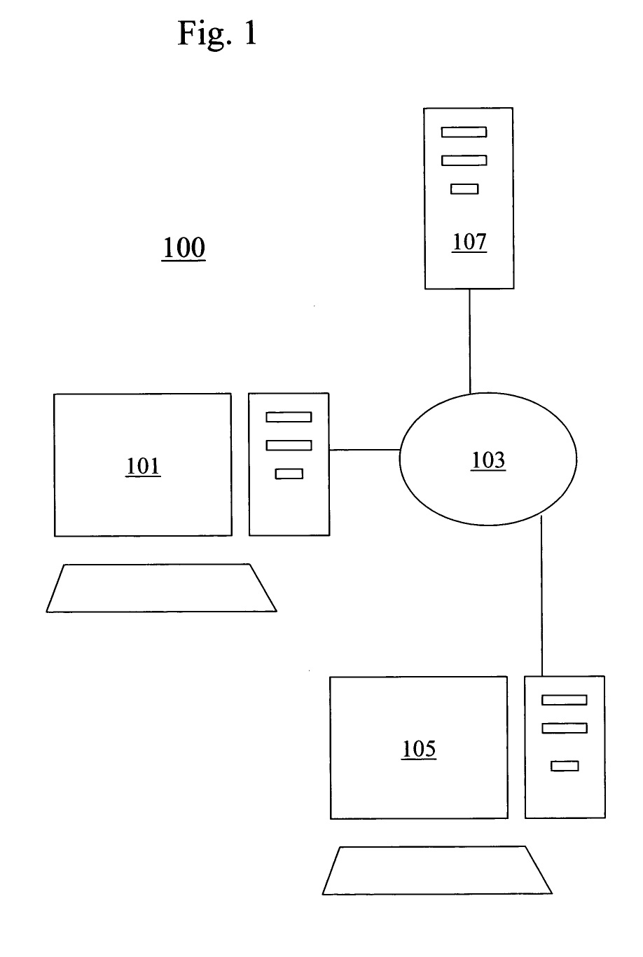

FIG. 1 illustrates a block diagram of an electronic matching system. The electronic matching system 100 comprises: a first end user computer 101, a network 103, a second end user computer 105 and a web server 107. Although, there is only one first end user computer 101 and second user computer 105 shown in the diagram, first and second end user computers 101 and 105 may be replaced with a multiple or a plurality of computers or similar devices that interact with the network 103 and the web server 107. In addition, although there is only one web server 107 shown, this web server 107 may be replaced with a multiple or a plurality of web servers. In this description, the terms first user and first end user are equivalent so they will be used interchangeably. In addition, the terms second user and second end user are also similar so they will be used interchangeably.

Preferably, the first end user computer 101 and the second end user computer 105 includes a memory, a processor, and firmware that performs functions, such as the rerouting of incoming data to a printer, flat screen, cathode ray tube, a video screen or any typical display device. In a preferred embodiment, the first end user computer 101 and the second end user computer 105 may be a conventional computer, personal digital assistant (PDA), laptop computer, notebook computer, mobile telephone or any other device that can receive and send information through a communication device. First end user computer 101 and second end user computer 105 may also include a display device, a keyboard, a mouse, a touch panel, a graphical user interface (GUI), a printer, a scanner and any other standard accessory devices associated with a conventional computer.

In the preferred embodiment, first end user computer 101 and second end user computer 105 transmits and receives information from web server 107 by utilizing network 103. In the preferred embodiment, network 103 represents, for example, the Internet which is an interconnection of networks. In addition, the network 103 may be a local access network (LAN), a wireless local network, a wide area network (WAN), a metropolitan area network, a virtual area network, an Ethernet link, a satellite link, cable, cellular, twisted-pair, fiber-optic or any network that is able to facilitate the transfer of data between computers or communication devices. Further, in traversing the network 103, the data may be transferred through several intermediate servers and many routing devices, such as bridges and routers. Preferably, web server 107 includes a program that is housed on a conventional computer that awaits and fulfills the requests from the first end user computer 101 and the second end user computer 105. This web server 107 transmits to the first user computer 101 and second user computer 105 a response to the inputted information or request in a Hypertext Transfer Protocol (HTTP), such as Hypertext Markup Language (HTML) pages or files. Normally, every computer, such as first end user computer 101, second end user computer 105 and web server 107, are connected to a web site on the Internet that must have a web browser program. Web browsers often come as part of a larger package of Internet and Intranet-related programs typically stored on a computer's memory, processor or mass storage, which provide Internet client functionality.

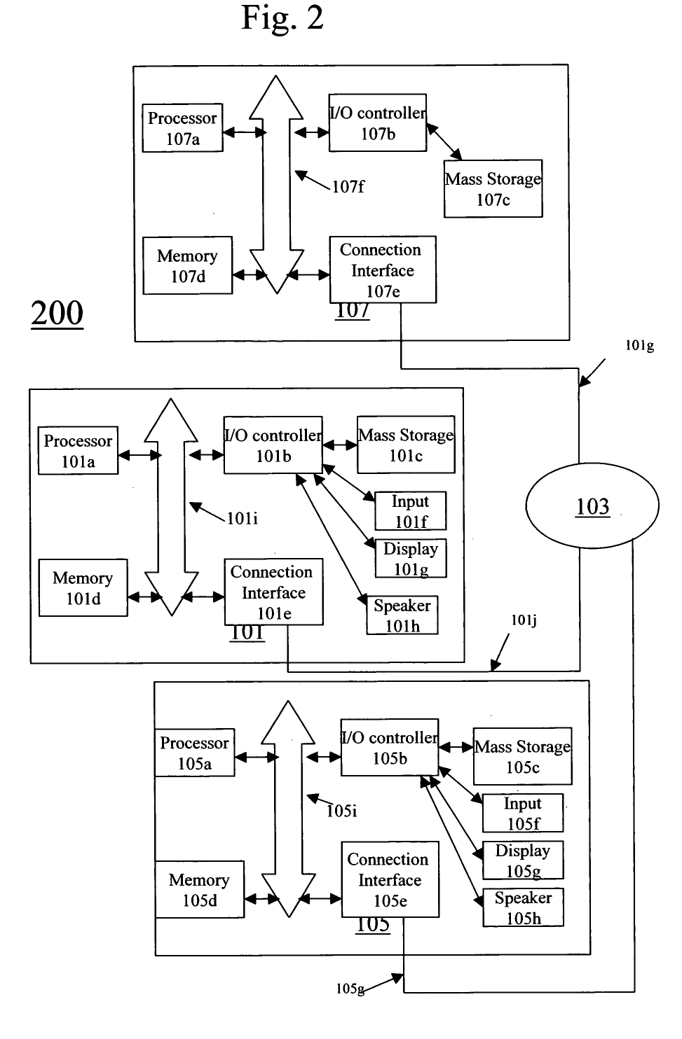

FIG. 2 illustrates a schematic diagram 200 of an embodiment of the electronic matching system of FIG. 1. First end user computer 101, second end user computer 105 and web server 107 include the typical components associated with a conventional computer. For example, first end user computer 101 includes: a processor 101a, an input/output (I/O) controller 101b, a mass storage 101c, a memory 101d, a connection interface 101e, an input 101f, a display 101g, a speaker 101h, a bus 101i and a communication link 101j. The connection interface 101 e may be referred to as a receiver. Connection interface 101e may also be a software algorithm that is compatible with the communication link 101j. For example, the connection interface 101e may be an application program interface (API) program compatible with the communication links 101j. Alternatively, the connection interface 101e may be a hardware device having pre-processing functionality that is compatible with the communication link 101j. For example, the connection interface 101e may be a network interface, optical sensor interface, or Ethernet interface that is compatible with the communication link 101j. In another embodiment, the connection interface 101e may be implemented as a combination of software and hardware that is compatible with the communication link 101j. Further, the connection interface 101e may include software functionality to decode, decrypt, authenticate or otherwise implement secure communications between the first end user computer 101 and the web server 107. Mass storage 101c may be referred to as a storage device. Processor 101a of first end user computer 101 may be a Pentium processor, microprocessor, digital signal processor or any typical processor used in an electrical device. Memory 101d of the first end user computer 101 may include a flash memory, static read only memory, electronic erasable program read only memory, any static random access memory or any typical computer memory.

At first end user computer 101, a person or user employs input 101f to input information that is transferred through the I/O controller 101b, processor 101a and bus 101i to the connection interface 101e. The information inputted into the first end user computer 101 may be any public information, private requirements information with its corresponding attributes, rankings, importance level and an identifier, which is transmitted through the network 103 to the web server 107. For example, the user may submit his public information, such as his name, age, gender and private requirements information or attributes concerning occupation, fetishes, the caste he is a part of, if he wants to have children etc and ranking of the attributes of the private requested information and the importance level of the attributes. In addition, the first end user inputs identifier information that includes the first end user's name and type of match requested or any type of identifier information the first end user deems to be suitable. When the connection interface 101e receives the inputted public information, private requirements information attributes, rankings, importance level and identifier, then the connection interface 101e utilizes the communication link 101j to transmit this received information to network 103. When network 103 receives the information it transmits the information through the communication link 107g to the connection interface 107e at the web server 107. Communication link 107g is equivalent to the communication link 101j described above so a description herein is not required. Connection interface 107e is equivalent to connection interface 101e so a description herein is not disclosed. Memory 107d is equivalent to memory 101d described above. Processor 107a is similar to the processor 101a also described above. However, processor 107a includes a matching process algorithm. This matching process algorithm compares the public information, private requested information attributes, rankings and importance level and identifier of the first end user with the equivalent information of the second end user to determine if there is a match or similarity between the information provided by the first end user computer 101 and second end user computer 105. Based on the similarity of the information provided by the first user and the second user a match or may not occur.

At the connection interface 107e, the inputted public information, private requirements information attributes, rankings, importance level and identifier is transferred through the connection bus 107f and I/O controller 107b to the mass storage 107c and processor 107a. Mass storage 107c or storage device and processor 107a stores this inputted information under the identifier. When the mass storage 107c categorizes the identifier into the type of match and alphabetical listing of the person's name, then the information is sent to a web browser on web server 107 that displays the information on an accessible website. Second end user computer 105 is able to view the website on display 105g when the second end user computer 105 utilizes communication link 105j and its web browser to connect through network 103 to access the web site of web server 107. Network 103 accesses the website on web server 107 when it is connected by the communication link 107g to connection interface 107e.

A second user utilizes second end user computer 105 to review the information on the accessible website displayed on display 105g and determines if a second user's information matches with the wants or needs of the first end user. The second end user employs input 105f to input information that is responsive to the information from the first end user computer 101, which is transferred through the I/O controller 105b, bus 105i and communication link 105j to the connection interface 105e. Communication link 105j is equivalent to the communication link 101j described above so a description herein is not required. Memory 105d is equivalent to memory 101d described above. Processor 105a is similar to the processor 101a also disclosed above. Connection interface 105e is equivalent to the connection interface 101e described above. Since the information from second end computer user 105 is responsive to the information from the first end user computer 101 it contains a flag that is recognizable to processor 107a. This flag may be the second user's name and the name identifier for the information associated with the first end user computer 101. The information inputted into second end user computer 105 may be any public information and private requirements information attributes, rankings and importance level and the second user identifier, which are transmitted to the web server 107. For example, the second end user may submit his public information, such as name, age, gender and private requirements information attributes concerning occupation, fetishes, the caste he is a part of, if he wants to have children etc, the importance level and ranking of all of the inputted information. When the connection interface 105e receives the inputted information, then the connection interface 105e utilizes the communication link 105j to transmit this information to the network 103. Network 103 transfers this received information to the communication link 107g and connection interface 107e at the web server 107.

At the connection interface 107e, the inputted information from second end user computer 105 is transferred through the connection bus 107f and I/O controller 107b to the mass storage 107c and processor 107a. Mass storage 107c stores this inputted information under the second end user identifier. Since the second end user identifier is responsive to the information from the first end user computer 101, this information from the second end user computer 105 is compared by the (matching process algorithm) processor 107a with received information from the first end user computer 101 to determine if there is a match or overlap. If there is a match or overlap in the information from the first end user computer 101 and the second end user computer 105, then the processor 107a sends a notification message through bus 107f, connection interface 107e and network 103 to the communication links 101h and 105j and connection interfaces 101e and 105e of the first end user computer 101 and second end user computer 105. The notification may be an electronic mail or any type of correspondence. Preferably, the notification will include all of the public information and matching or overlapping information designated by rankings by the first end user computer 101 and second end user computer 105.

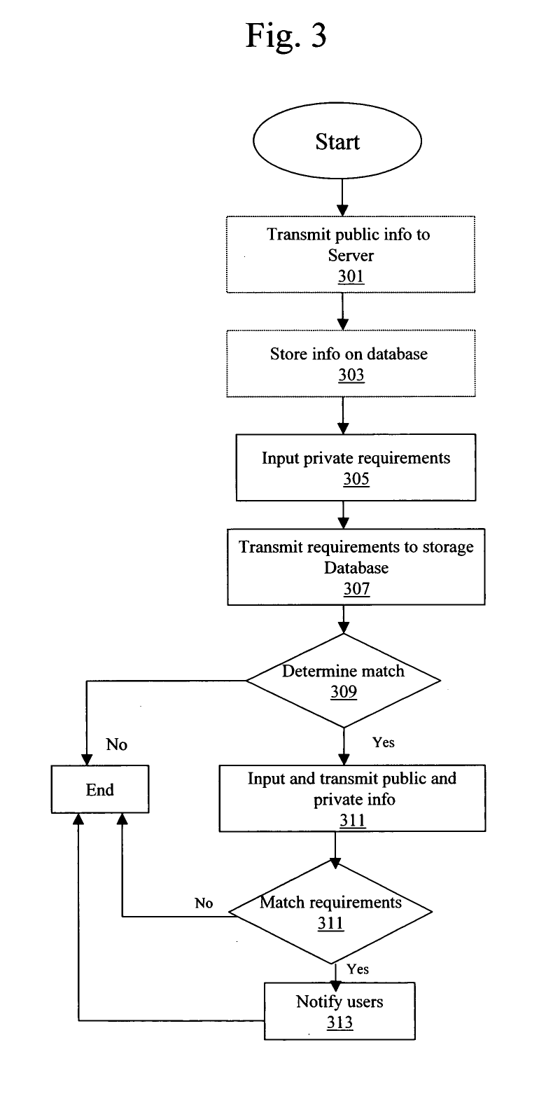

FIG. 3 is a flow chart that depicts an example of how the electronic matching system functions. At block 301, a person at the first end user computer 101 (FIG. 2) optionally inputs and transfers public information to the web server 107. The public information may contain a first end user's name, address, phone number, occupation and an identifier. The identifier can be the first end user's name and a category, such as romantic match, business match, friendship match etc. In another embodiment, the public information may include the first end user's gender, age, weight, body measurements, hobbies, interests etc. Web server 107 receives the information, at block 303, then stores the information in mass storage 107c (FIG. 2) under the identifier. This identifier is transmitted to the processor 107a along with the public information. When the mass storage 107c categorizes the information or flag, then the information is transmitted to the web browser on web server 107 that displays the information on an accessible website on network 103 so that the information of the first end user computer 101 may be matched with information from the second end user computer 105.

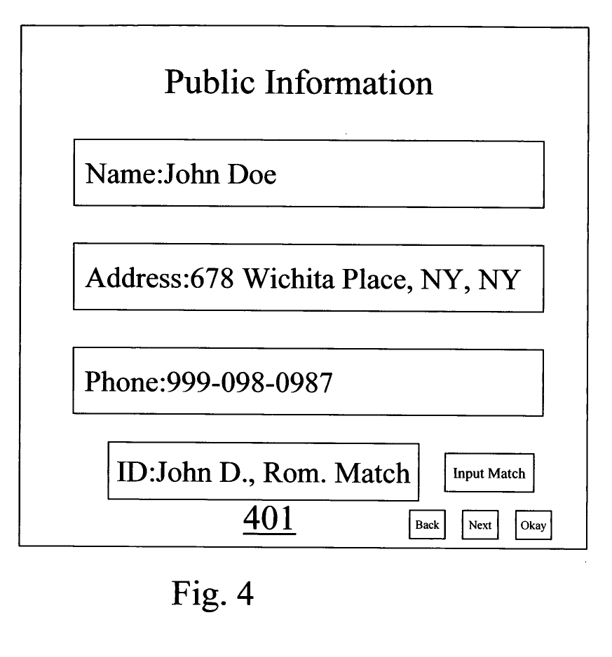

FIG. 4 illustrates an example of the public information that may be displayed on the accessible website. The public information includes: a name field, an address field, a phone field and an identifier field, where the first end user utilizes first end user computer 101 to input his information. For example, John Doe is in the name field, 678 Wichita Place, NY, N.Y. is in the address field, 999-098-0987 is in the phone field and John D. Rom. match is in the identifier field. In addition, this public information field may also be expanded to include fields for: gender, sporting activities, hobbies, interest, occupation, education, political parties and any other public information a person may want to display. Further, the website may include: a back button to return to a previous website page and make any corrections; a next button to skip to the next website page; an okay button to declare that all the information is correct; and a input match button to initiate a new public website page to insert information associated with the previous website page or first user website page.

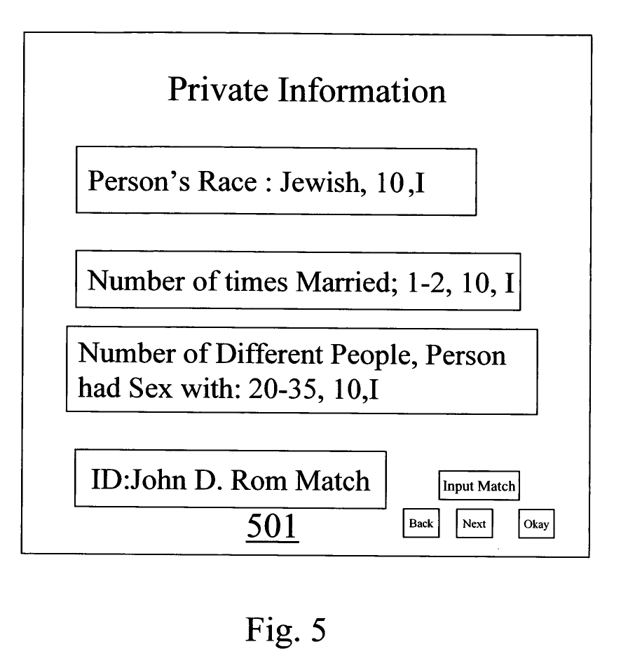

Referring to FIG. 3, at block 305 the person at the first end user computer 101 inputs private requirements information attributes, rankings and importance level. These private requirements information attributes, rankings and importance level are transferred through connection interface 101e (FIG. 2), communication link 101j, network 103 to communication link 107g and connection interface 107e. The private requirements information relates to information associated with a romantic match, business match, friendship match, a networking match or any type of standard match. In one embodiment, referring to FIG. 5, the private requirements information relating to a romantic relationship match include the attributes, rankings and importance level for: the person's race field, the number of times the person had sex with different people field and how many times the person has been married. In another embodiment, the romantic relationship match includes the attributes, rankings and importance level for: fetishes the person has field, body measurements field, casual dating with no sex field, casual dating with sex field, dating with a long-term commitment intended field, finding a person to marry but no children field and finding a person to marry and have children field. In yet another embodiment, the romantic relationship match includes the attributes, rankings and importance levels include fields for personality: quiet, studious, book smart, athletic participant, watching sports, partying with friends, enjoy going out socially to bars, enjoys going to upscale places and any other private characteristics that the first person requests.

The private requirements information that relates to business match attributes, ranking and importance levels include fields for: type of occupation, how long the person worked in different jobs, what kind of experience did he gain, where does he want to relocate, why does he want to relocate, what do you want out of a new job, last year's income, expected income and any other private requirements information associated with an occupation or business. Each of the attributes of the private requirements information, discussed above, has a ranking in the range of 1-100 inputted by the first end user. Preferably, the ranking of the attributes will be in the range of 1-10, where 10 dictates a high level ranking, 5 is a middle level ranking and 1 is the lowest level ranking. In addition, each of the ranked attribute may or may not have an importance level denoted by the symbol I or any suitable symbol also inputted by the first end user. The importance level I may be used as an absolute determinant, as determined by the first end user, for there to be a match between the first and second end user. For example, if all of the public information and private requirements information attributes and rankings match each other and the importance level does not match, then the matching algorithm will not match the first end user with the second end user.

At block 307, when the private requirements information, attributes and rankings from the first end user computer 101 reaches connection interface 107e (FIG. 2) the information is transmitted through the bus 107f and I/O controller 107b to mass storage 107c and processor 107a. Mass storage 107c stores this inputted information under an identifier, such as the name of the first end user and category, such as a romantic match, business match, friendship match, network match etc., as designated by the first end user computer 101, which is also stored on processor 107a. When the mass storage 107c categorizes the information or flag, then the information is sent to web browser on web server 107 that displays the information on an accessible website associated with network 103.

Next, the second user computer 105 (FIG. 2) accesses the web site of web server 107 on display 105g, where the public information (FIG. 4) and private requirements information (FIG. 5) may be shown on different web pages. After the second end user views the public information, then he clicks the NEXT button (FIG. 4) to go to the private requirements information displayed on the website, then he determines at block 309 if he wants to be matched with the first end user at first end user computer 101. If the second end user does not want to be matched with the first end user, then the program ends. However, if the second end user does want to be matched up with the first end user, then the second user utilizes the second end user computer 105 to click on the BACK button and INPUT MATCH button to input information related to the public requirements information and private requirements information associated with the first end user.

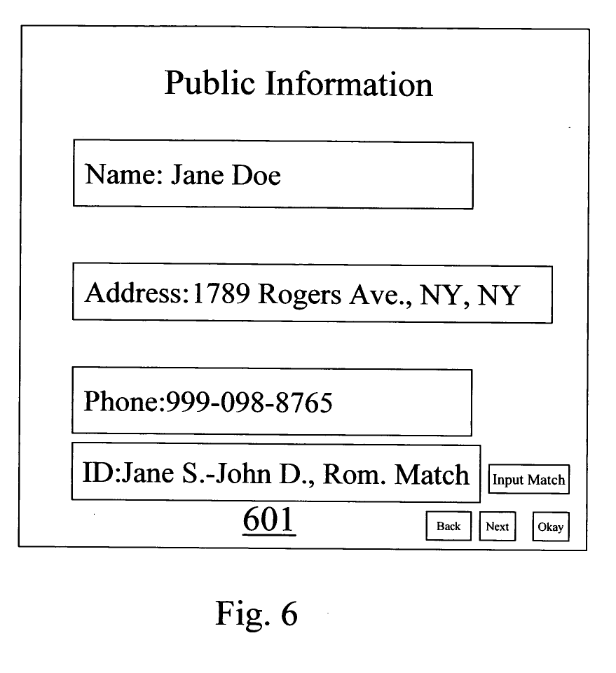

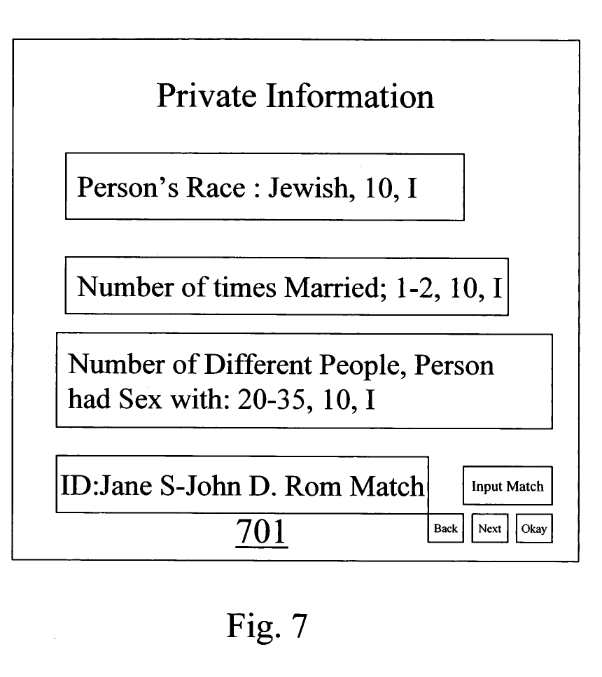

The second end user utilizes input 105f (FIG. 2) to input, at block 311, the public and private requirements information attributes, rankings, importance level and an identifier, which is similar to the information inputted by first end user as shown in FIGS. 4 and 5. The identifier from the first end user is responsive to the identifier from the second end user. For example, referring to FIG. 6, the inputted public information for the second user computer 105 includes: Jane Smith in the name field, 1789 Rogers Ave, NY, N.Y. in the address field, 999-098-8765 in the phone field and Jane S-John D., Rom. Match in the identifier field. The Jane S-John D., romantic match informs the processor 107a at web server 107 that the matching process algorithm, described above, stored on processor 107a must be activated to determine if one or more of the attributes, rankings and importance levels of the first end user matches with that of the second end user. Referring to FIG. 7, for example the private requirements information attributes, rankings and importance levels include fields for: person's race field ranked at 10 and I (importance level), number of times married 1-2 times ranked at 10 and I, number of times the person had sex with different people field at 20-35 times ranked at 10 and I and the Jane S-John D. Rom. Match for the identifier field. After the public information, private requirements information attributes rankings and importance level and identifier are inputted into second end user computer, then the information is transferred through the network 103 to the web server 107.

At the web server 107, the public and private requirements information attributes, rankings, importance levels and identifier are transmitted to the mass storage 107c and processor 107a. At the mass storage 107c, the received information is stored and archived. While at the processor 107a, this processor 107a detects the identifier of Jane S-John D., romantic match that signifies the public and private requirements information attributes, rankings and importance level should be compared to the private requirements information from the first end user computer 101 by using the matching process algorithm stored on processor 107a to determine, at block 313, if one or all of the attributes, rankings and importance level of the first end user matches with that of the second end user.

There are several ways the matching process algorithm stored on the processor 107a may be activated for romantic matching, business matching, friendship matching, relationship matching, networking matching, job search, product procure matching, investor matching etc. For each of the attributes of the private requirements information based on the rankings and the importance level one attribute may valued above all others. For example, if the first end user determines that a person being Jewish ranks 10 and this ranking is the most (I) important than any other attribute, then this ranking will be noted when it is transmitted to the web server 107. This important level (I) may referred to as the first user defined determining aspect for the first user and second user defined determining aspect for the second user. The first end user may put a notification or flag next to the particular attribute, such as an I for important. When the matching process algorithm on processor 107 observes that the person's race being Jewish ranked 10 and having a symbol I is significant for the first end user, then all other private requirements information attributes of the second user that do not have the person's race being Jewish ranked 10 and having an I symbol will be discarded. The matching process algorithm will use the I symbol as an absolute determining factor to match the first end user to the second end user, because the first user requires that he be matched with someone that is Jewish ranked 10 and has an I symbol in the second user's private requirements information attribute.

In another embodiment the first end user may determine that two or more attributes, rankings and importance levels of his private requirements information must match with the attributes of the second user private requirements information for there to be a match. For example, the private requirements information for the first end user computer attributes may include: a race of Jewish must be ranked at 10, the person being married 1-2 times must be 10 and the person having sex between 20-35 times must be ranked at 10 must match with the attributes rankings of the second end user for there to be a match. In this case, the first end user can put a notification of flag of I (important) next to the rankings of each of the attributes. The matching process algorithm utilizes the I symbols for the first end user's attributes of the private requirements information to determine if the second user also includes the equivalent attributes, rankings and importance level for there to be a match.

In yet another embodiment, the first end user may determine that all of the attributes private requirements must have an overlap total or match. For example, the private requirements information attributes of the first end user computer 101 includes a person's race being Jewish ranked 10, how many times the person has been married 1-2 times being ranked 10, how many times the person had sex with different people at 20-35 ranked 10, fetishes the person has of sucking someone's toes ranked 10 is equivalent to the private requirements information ranking of attributes for the second end user computer 105. In this scenario, the first end user computer 101 can input an I (important) symbol or any suitable symbol after each ranking to show that it is essential and should be taken into account when the matching process algorithm of processor 107a is utilized. Thus, all of the second user's private requirements information attributes, rankings and important level must be equivalent to the private requirements information associated with the first user for there to be a match.

With regard to a business match, the private requirements information for the first end user computer may include the attributes for fields that include: type of occupation, how long the person worked in different jobs, what kind of experience did he gain, where does he want to relocate, why does he want to relocate, what do you want out of a new job, previous income, expected income and any other private requirements information association with an occupation. These business match attributes also have the same rankings and importance levels as the romantic match attributes described above. Each individual business match rankings determines the match between the first and second end users or the overlap total will determine the match between the first and second end users. For example, the first end user computer 101 attributes include a ranking of 10 for the type of occupation being an attorney and the ranking of 8 for the person working at two jobs for 10 years. Each of the aforementioned attributes may have an I (important) level, which must be taken into account when determining the matching process. If these ranking and attributes of the information from the first end user computer 101 matches with the attributes, ranking and importance level of the private requirements information from the second end user computer 105, as determined by processor 107a, then there would be a match. All other types of matching processes, such as a friendship match, networking match, job search match, product procurement match, investor match etc will operate in the same manner as the business and romantic matches described above. If one or all of the public and private requirements information attributes, rankings and importance level of the first end user does not match with the second end user then the process returns to 309.

At block 315, the matching process algorithm on processor 107a determines there has been a match between the public and private requirements information attributes, rankings and importance level of the first end user and the second end user. Processor 107a transmits an electronic mail message through bus 107f, connection interface 107c, communication link 107g and network 103 to the first end user computer 101 and second end user computer 105 informing them of the match. Preferably, the processor 107a provides the first end user computer 101 and second end user computer 105 all of the public information and private requirements information attributes, rankings and importance level. In another embodiment, processor 107a may inform the first end user computer 101 and second end user computer 105 of the match by regular mail, facsimile, telephone or any standard correspondence means, then the process ends.

This invention provides a person with a simple means to become matched or connect with someone based on the person's preferences. This device allows a user to determine who he/she wants to be matched based on his established criteria matching with another person's criteria. It enables a person to be simply and effectively matched with someone else based on the person's own attributes, rankings and importance level, which decreases the possibility of people being erroneously matched.

It is intended that the foregoing detailed description be regarded as illustrative rather than limiting and that it be understood that it is the following claims, including all equivalents, which are intended to define the scope of the invention.

1. A system for matching one entity to another, the system comprising:
a first user computer coupled to a network, wherein the first computer is configured to transmit a first set of private requirements information including a first user defined determining aspect to the network;
the network coupled to a server, wherein the server is configured to receive the first set of private requirements information with the first user defined determining aspect;
a second user computer coupled to the network, wherein the second computer is configured to transmit a second set of private requirements information with a second user defined determining aspect to the network; and
the server coupled to the network, wherein the server is configured to receive the first and second set of private requirements information, wherein the server is configured to determine if there is a match between the first and second set of private requirements information based on the first and second user defined determining aspects.

2. The system of claim 1, wherein the first user defined determining aspect is associated with an attribute of the first set of private requirements information.

3. The system of claim 2, wherein the attribute includes a ranking.

4. The system of claim 3, wherein the ranking is in the range of 1 to 10.

5. The system of claim 1, wherein the second user defined determining aspect is associated with an attribute of the second set of private requirements information.

6. A method for matching one entity to another entity, the method comprising:
transferring a first set of private requirements information with a first user defined determining aspect;
receiving the first set of private requirements information with the first user defined determining aspect;
transferring a second set of private requirements information with a second user defined determining aspect;
receiving the second set of at least one private requirements information with the second user defined determining aspect; and
determining if there is a match between the first set of private requirements information and the second set of private requirements information based on the first and second users defined determining aspects.

7. The method of claim 6, further comprising notifying a first user associated with the first set of private requirements information if there is a match between the first and second users defined determining aspects.

8. The method of claim 6, further comprising notifying a second user associated with the second set of private requirements information if there is a match between the first and second users defined determining aspects.

9. The method of claim 6, wherein notifying comprises electronic mail.

10. The method of claim 7, wherein notifying comprises facsimile.

11. The method of claim 7, further comprising transferring a first set of public information.

12. The method of claim 6, further comprises transferring a second set of public information.

13. The method of claim 12, further comprises receiving the first set of public information.

14. The method of claim 6, further comprising receiving the second set of public information.

15. An apparatus for matching one entity to another entity, the apparatus comprising:
a receiver configured to receive a first and second set of private requirements information with a first and second users defined determining aspects;
a storage device coupled to the connection interface configured to store the first and second set of private requirements information with the first and second users defined determining aspects; and
a processor coupled to the storage device configured to determine if there is a match between the first and second set of private requirements information based on the first and second users defined determining aspects.

16. The apparatus of claim 15, wherein the receiver comprises a connection interface.
